(19) United States
(12) Patent Application Publication
(10) Pub. No.: US 2004/0232712 A1
(43) Pub. Date: Nov. 25, 2004

(54) Spatula turner

(76) Inventors: Jeff Siegel, Kings Point, NY (US); Adam Krent, Brooklyn, NY (US); David Linn Burnett, New York, NY (US); William J. Lazaroff, Floral Park, NY (US); Alison Waite Lincoln, Brooklyn, NY (US)

Correspondence Address: GOODMAN & TEITELBAUM, SUITE 1400, 26 COURT STREET, BROOKLYN, NY, 11242, US

(21) Appl. No.: 10/442,954

(22) Filed: May 22, 2003

(51) Int. Cl. A47J 43/28

(52) U.S. Cl. 294/7

(57) ABSTRACT

A spatula turner has a handle defining a spatula axis and a shank extending from the handle. A generally flat spatula blade is connected to the shank and has at least two opposing curved scrapping edges that bow outwardly or are convex and are substantially parallel to the spatula axis. The spatula blade defines a plane of substantial symmetry co-extensive with the spatula axis and extends through the scrapping edges. The blade defines two regions, one region more approximate to the handle and one region more remote from the handle, the more remote region having a thickness in relation to the plane of symmetry that is less than the thickness of the more proximate region and is preferably provided with a chamfered edge to render the more remote region more flexible and suitable for introduction under the food product on a surface of a pan on which it is being prepared.

### BACKGROUND OF THE INVENTION

1. Field of the Invention

The invention generally relates to kitchen utensils and, in particular, to a spatula turner.

2. Description of the Prior Art

Previous spatulas have been designed with flexible rubber heads. Also, many spatulas are provided with generally straight scrapping edges that do not generally conform to the shapes of the surfaces of food processors and other vessel interiors or storage containers to be scraped.

Turners and spatulas have been frequently separate and distinct kitchen utensils. Spatulas tend to be thicker than turners. Typically, turners are made of thin sheet metal that provides the requisite stiffness while being sufficiently thin to be inserted between a cooking surface and the food item being cooked thereon. Thus, a turner spatula should ideally have a number of desired properties, including sufficient overall rigidity to efficiently scrape surfaces of food processors containers, cooking vessels and other containers; having edges sufficiently flexible to conform to the surface configurations of the surfaces to be scrap and yet be sufficiently thin and configured to enable the spatula to be inserted between a food item and a cooking surface while also being able to withstand high temperatures.

### SUMMARY OF THE INVENTION

In order to overcome the disadvantages inherent the prior art spatulas/turners, a spatula turner in accordance with the present convention comprises a handle generally defining a spatula axis. A shank is provided having one end extending from such handle along such spatula axis. A generally flat spatula blade is connected to the other end of such shank and has at least one scrapping edge that is substantially parallel to said spatula axis, such spatula blade defining a plane of substantial symmetry coextensive with said spatula axis and extending through said opposing edges. Said blade defines two regions one more approximate to said handle and one region more remote from said handle, said more remote region having a thickness in relation to said plane of symmetry which is less than the thickness of said more proximate region to render said more remote region more flexible and suitable for introduction under food product in a pan. Preferably, said at least one scrapping edge is provided with a chamfered edge on at least one side of said plane of substantial symmetry.

### BRIEF DESCRIPTION OF THE DRAWINGS

The above and other objects of the invention may be more readily seen when viewed in conjunction with the accompanying drawings, wherein:

FIG. 1 is a front elevational view of a spatula turner in accordance with the present invention;

FIG. 2 is a front elevational view similar to FIG. 1, but showing a phantom outline of the chamfered edge that is provided about a substantial portion of the periphery of the spatula blade;

FIG. 3 is a cross-sectional view of the spatula shown in FIG. 2, taken along line 3-3;

FIG. 4 is a cross-sectional view of the spatula blade shown in FIG. 2, taken along line 4-4;

FIG. 5 is a side elevational view of the spatula shown in FIG. 1, shown partially broken away to illustrate the altered shank design.

### DESCRIPTION OF THE PREFERRED EMBODIMENT

Referring now specifically to the figures, in which identical and similar parts are designated by the same reference numerals throughout, and first referring to FIG. 1, the spatula turner in accordance with the present invention is generally designated by the reference numeral 10.

The spatula turner 10 includes a handle 12 generally defining a spatula axis A. A shank 14 extends from the handle 12 along the spatula axis and defines a proximate shank end 14a and a remote shank end 14b. A generally flat spatula blade 16 is connected to the remote end 14b of the shank and has at least one scrapping edge 16a, 16b substantially parallel to the spatula axis A. However, while all the embodiments shown illustrate two scrapping edges 16a, 16b, it should be evident that a single scrapping edge may be provided and the opposing edge may be configured in any desired shape for possibly non-scrapping function. While the scrapping edges 16a, 16b are generally parallel to the spatula axis, it would also be clear from FIG. 1 that the edges are not straight but, instead, arcuate as shown. Thus, the scraping edges are provided with a transition portion 16c which extends from the remote shank end 14b to the maximum width region 16d while the remote region 16e curves continuously inwardly towards the axis A to provide an end portion 16f at the free end of the spatula blade, where a generally straight transverse edge 16g is provided. While the specific curve used for the region 16e between the maximum width region 16d and the minimum width region 16f is not critical, the curvature of the scrapping edge 16e may generally be circular with a radius of approximately within the range of 300-400 mm, appropriately centered, to provide the illustrated curvature. Preferably, the radii of curvature of the edge portion 16e are in the range of 340-350 mm, and in the embodiment illustrated, the radius is about 344 mm. The remote shank end 14b is provided with a shank extension 14c that has a width somewhat less than the width of the shank end 14b to provide a lip or abutment surface 14e as shown in FIG. 1. The spatula blade 16 is formed about the shank extension 14c in a suitable manner to provide a permanent bond.

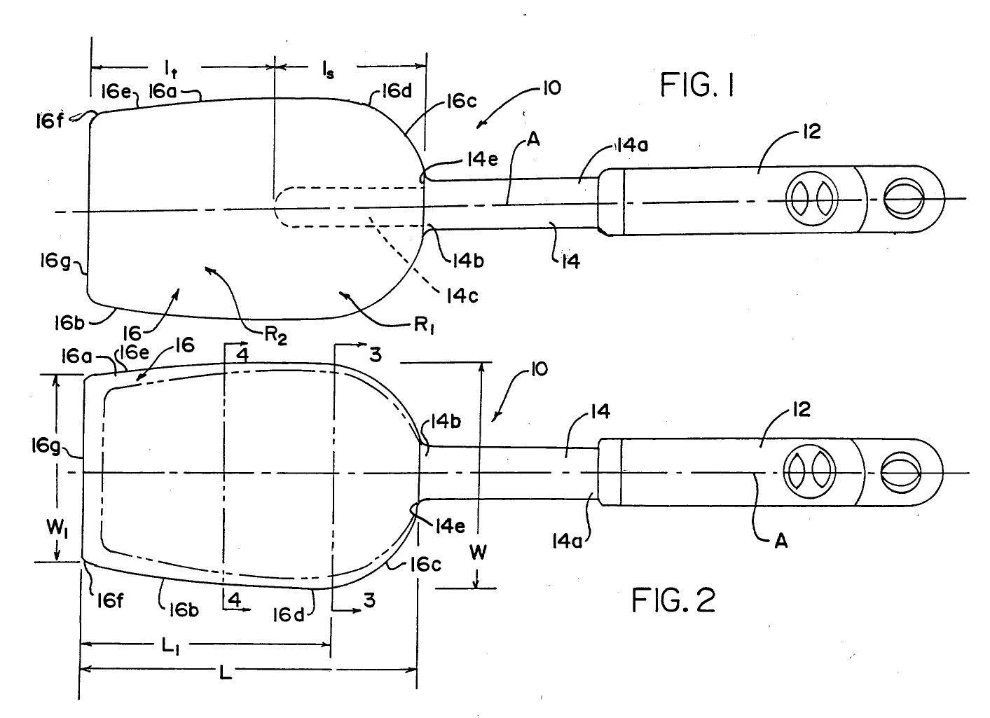

As best shown in FIG. 2, the maximum width of the spatula blade 16 is W while the width of the spatula blade at the remote or free end 16g is w₁ While the specific dimensions are not critical and are relative to each other, one presently preferred embodiment has a maximum width W of approximately 80 mm and a width w₁ of approximately 68 mm.

While referring to FIG. 1, the blade 16 generally defines two regions R₁, R₂ respectively more proximate and more remote from the handle 14. Generally, these regions correspond to that length of the spatula which embeds the shank extension 14c and that portion of the blade that does not. Thus, the region R₁ generally has an axial length lₛ and the region R₂ has an axial length of l₁. Referring to FIG. 5 it would be evident that the region R₁ has a thickness in relation to the plane of symmetry P which is greater than the thickness of the more proximate region R₂ to render the more remote region more flexible and suitable for introduction under a food product in a pan.

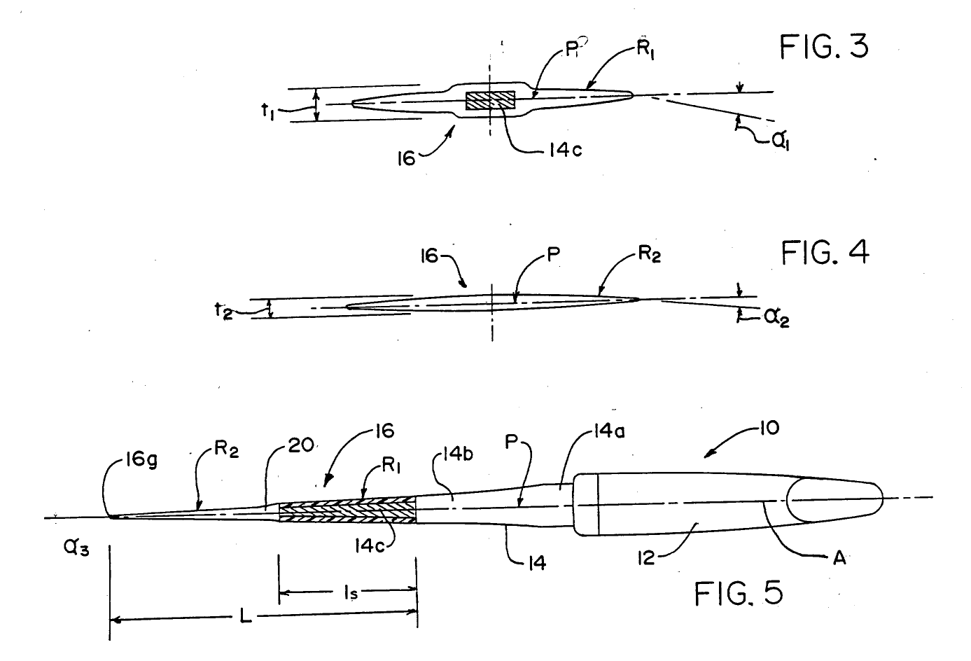

Referring to FIGS. 3 and 4, it would also be evident that in the region R₁, which embeds the shank extension 14c, the thickness t₁ is greater than the thickness of t₂ of the shank blade taken in region R₂. As best shown in FIG. 5, there is provided a generally tapering transitional region 20 that provides a degree of thickness reduction.

In order to render the design more suitable for use as a turner, at least one of the scrapping edges 16a, 16b is provided with a chamfered edge in a place substantially normal to the spatula axis. As illustrated in FIGS. 3-5, the angle of the chamfers may decrease in the direction of the edge 16g. The chamfered edge angle α₁ is shown, thus, as being equal to approximately 25 degrees when taken along the line 3-3 in FIG. 2, while α₂ has been reduced to 14 degrees when taken along line 4-4 in FIG. 2. In FIG. 5, the angle α₃ of the chamfered edge along the lower edge is equal to 10 degrees. Thus, the thickness and flexibility of the edge gradually increases from the region of the shoulder 16c to the free flat remote edge 16g where the thickness of the edge is the thinnest and most suitable for insertion between a food product and a surface on which is being prepared, such as a pan.

As shown above, the angle α decreases from the region of the shank 14 to the transverse free edge 16g to provide a reasonable degree of flexibility while still being sufficiently stiff in the region R₁ and in the transition region 20 along the lateral edges 16a, 16b to provide effective scrapping while being especially thin along the lower edge to facilitate insertion under a food item turning it. The spatula defines a plane of substantial symmetry. That plane P of substantial symmetry is co-extensive with the axis A. However, it would be clear from FIGS. 3-5 that in the preferred embodiment illustrated the chamfered edge is provided along only one side of the spatula so that symmetry is not perfect. However, it is also possible to provide two chamfered edges one on each side of the plane of symmetry.

In order to provide the desired degree of stiffness in the upper region of the scrapping edges while providing significantly more flexibility for purposes of turning in the lower part of the spatula blade, the shank extension 14c is preferably provided with a length which is less than half of the actual dimension of the spatula blade. Thus in FIG. 1, the distance lₜ is greater than the distance lₛ. Stated otherwise, the length of the shank extension 14c is preferably less than one-half of the overall length L of the spatula blade (FIG. 2).

While the shank extension is shown to have a generally rectangular cross-section in FIG. 3, this is not a critical feature of the invention and any other suitable cross-section may be used.

An important feature of the invention is that the spatula blade is made from silicon, providing it not only with the requisite degree of desired stiffness, when reinforced by the shank extension 14c, but is also provided with the requisite desired flexibility along the chamfered edge particularly along the remote region R₂.

With the arcuate curvatures of the scrapping edges 16a, 16b, the percentage reduction in width from W (FIG. 2) to the remote width w₁ is in the range of 80-90%. In the illustrated embodiment, the percent reduction in width is approximately 84%. The aforementioned percentage reduction in width takes place over a distance of approximately 75% of the actual length of the spatula blade or over the distance L₁ (FIG. 2). In the presently preferred embodiment, the Length L of the spatula blade is approximately 122 mm while the reduction in width takes place over the distance L₁ of approximately 91 mm.

The spatula turner has two primary functions. The spatula has been shaped to scrape most kitchen devices efficiently. It has also been designed to be somewhat flat and flexible in order to pry under food in the pan and flip it over. The spatula turner has two specific functions that distinguish it over prior know spatula.

The spatula turner invention has been designed to function optimally in most brands of food processors. There are other existing food processors spatulas, but this one has been designed with a profile that fits well in certain vessel interiors, while also working well in other food processor bowls and other various cylindrical storage containers.

What is claimed:

1. A spatula turner comprising a handle generally defining a spatula axis; a shank having one end extending from said handle along said spatula axis; a generally flat spatula blade connected to the other end of said shank and having at lease one curved scraping edge that is substantially parallel to said spatula axis, said spatula blade defining a plane of substantial symmetry coextensive with said spatula axis and extending through said at least one opposing edge, said blade defining two regions one region more proximate to said handle and one region more remote from said handle, said more remote region having a thickness in relation to said plane of symmetry which is less than the thickness of said more proximate region to render said more remote region more flexible and suitable for introduction under a food product in a pan.

2. A spatula turner according to claim 1, wherein said regions are separated by a transition region that alters the thickness of said regions.

3. A spatula turner according to claim 2, wherein said transition region us tapered.

4. A spatula turner according to claim 1, wherein two opposing scrapping edges are provided each of which is substantially parallel to said spatula axis.

5. A spatula turner according to claim 1, wherein said at least one scraping edge is chamfered in a place substantially normal to said spatula axis.

6. A spatula turner according to claim 1, wherein said spatula blade defines a plane of symmetry coextensive with said spatula axis.

7. A spatula turner according to claim 1, wherein said shank has a free end portion embedded within said spatula blade.

8. A spatula turner according to claim 7, wherein said shank free end portion has a length along said spatula axis which is less than one half of the axial dimension of said spatula blade.

9. A spatula turner according to claim 1, said shank free end portion has a generally rectangular cross-section in cutting planes normal to said spatula axis.

10. A spatula turner according to claim 1, wherein said spatula blade defines a plane of substantial symmetry coextensive with said a spatula axis.

11. A spatula turner according to claim 10, wherein said at least one scraping edge is chamfered on one side of said plane of substantial symmetry.

12. A spatula turner according to claim 1, wherein said spatula blade is form3ed of silicon.

13. A spatula turner according to claim 10, wherein said at least one scraping edge is increasingly chamfered on at least one side of said plane of substantial symmetry from an axial end of said spatula blade most proximate to said handle to an opposing end most remote from said handle.

14. A spatula turner according to claim 1, wherein said at least one scraping edge is arcuate.

15. A spatula turner according to claim 14, wherein said arcuate edge is generally convex.

16. A spatula turner according to claim 15, wherein the width dimension of said spatula blade gradually and continually decreases from an intermediate region of maximum width to the free end of said spatula blade most remote from said handle.

17. A spatula turner according to claim 16, wherein the percentage reduction in width is in the range of 80-90%.

18. A spatula turner according to claim 17, wherein the percentage reduction in width is approximately 84%.

19. A spatula turner according to claim 18, wherein said percentage reduction takes place over a distance approximately 75% of the axial length of said spatula blade.

20. A spatula turner according to claim 1, wherein said embedded free end portion has a full rounded free end.
